(19) United States
(12) Patent Application Publication
(10) Pub. No.: US 2010/0221623 A1
(43) Pub. Date: Sep. 2, 2010

(54) Method and Apparatus for Operation of a Fuel Cell Arrangement

(75) Inventor: Markus Pabst, Guenzburg (DE)

Correspondence Address: CROWELL & MORING LLP;INTELLECTUAL PROPERTY GROUP, P.O. BOX 14300, WASHINGTON, DC, 20044-4300, US

(73) Assignees: Daimler AG, Stuttgart (DE); Ford Global Technologies, LLC, Dearborn, MI (US)

(21) Appl. No.: 12/676,315

(22) PCT Filed: Jul. 11, 2008
(86) PCT No.: PCT/EP2008/005670

§ 371 Date: Mar. 3, 2010

(30) Foreign Application Priority Data
Sep. 4, 2007 (DE) 10 2007 041 870.3

(51) Int. Cl. H01M 8/04; H01M 8/24

(52) U.S. Cl. 429/428; 429/452

(57) ABSTRACT

A method and an apparatus for operation of a fuel cell arrangement having a plurality of fuel cells which are combined to form a stack and have a common cathode input and cathode output, as well as a common anode input and anode output, and having first components which supply the fuel cells with reactants and second components which process the reaction products of the fuel cells. First and second components are surrounded by separate housings or by a common housing. Exhaust air containing hydrogen is passed directly from all of the housings into a combined exhaust air line in which the hydrogen content of the combined exhaust air is determined.

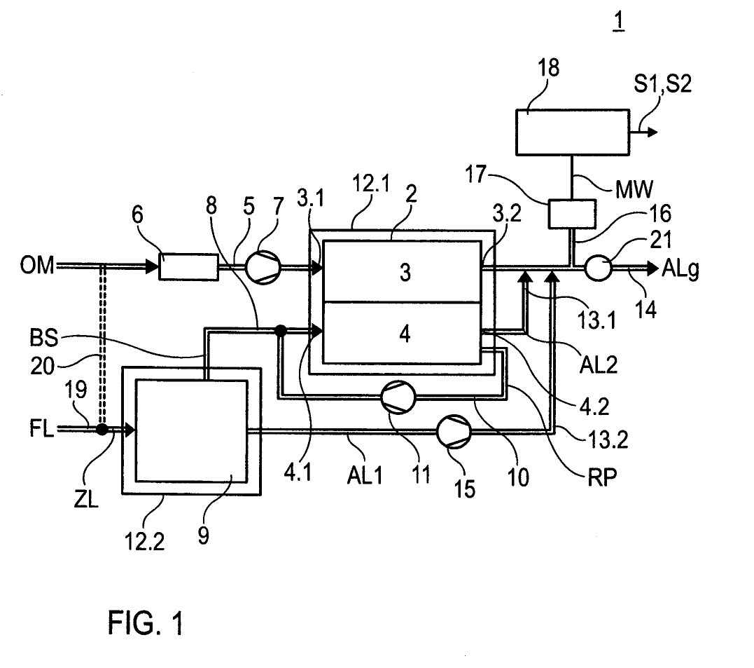

This application is a national stage of PCT International Application No. PCT/EP2008/005670, filed Jul. 11, 2008, which claims priority under 35 U.S.C. §119 to German Patent Application No. 10 2007 041 870.3, filed Sep. 4, 2007, the entire disclosure of which is herein expressly incorporated by reference.

### BACKGROUND AND SUMMARY OF THE INVENTION

The present invention relates to a method and an apparatus for operation of a fuel cell arrangement having a plurality of fuel cells which are combined to form a stack, a common cathode input and output, a common anode input and output, first components which supply the fuel cells with reactants, and second components which process the reaction products of the fuel cells.

Fuel cell arrangements having a plurality of individual fuel cells are used to generate electricity with low emission of hazardous substances. In this case, the fuel cells, which each have an anode and a cathode, on the one hand have a reactant containing hydrogen supplied to them as fuel, and on the other hand have a reactant containing oxygen supplied to them as the oxidant. The reaction product of the oxidation processes in the fuel cell is an air flow which emerges from the fuel cell and is loaded with water vapor and condensed water.

In this case, fresh air is first compressed in a compressor as the oxidant for the gas supply to the cathode, and is then cooled down in a boost air cooler. The air then flows into a humidifier module in which it absorbs water vapor from a cathode exhaust gas, flowing out on the cathode side, of the fuel cell or of a fuel cell stack. The humidified fresh air is then passed into the fuel cell or the fuel cell stack, where it takes part in the electrochemical reaction. The cathode exhaust gas flowing out on the cathode side is then supplied to the humidifier module where it emits water vapor to the air supplying the cathode. The cathode exhaust gas is then supplied to an exhaust gas turbine. By way of example, the anode of the fuel cell arrangement is supplied over-stoichiometrically via a metering valve with hydrogen as a fuel from a hydrogen reservoir. Hydrogen that has not reacted and nitrogen and water vapor passed to the cathode are compressed to the pressure level of the fresh gas again, by means of a fan (also referred to as a recirculation fan), and are fed into the hydrogen supply flow once again, via a feedback path.

One or more components—water reservoir, individual fuel cells, fuel cells interconnected to form a stack, humidifier, boost air cooler, fuel reservoir, coolant reservoir and/or electronic control systems—are normally surrounded either by a common housing or by separate housings for protection against mechanical damage and/or environmental influences, such as water spray or dirt. In this case, the housing which surrounds the respective housing interior with the component or components can be ventilated. For this purpose, the housing is provided with an apparatus for air exchange, which supplies fresh air to the input side of the housing and carries exhaust air away into the environment, via an exhaust air line, on the outlet side. Emissions of gaseous hydrogen from the exhaust gas lines of the fuel cell or cells during operation of the fuel cell or fuel cell arrangement, produced during operation, can form flammable mixtures in the area surrounding the exhaust gas line from the housing.

Furthermore, the air flow emerging from the fuel cell is loaded with water vapor and condensed water as a reaction product of the oxidation processes in the fuel cell. The condensed water droplets can be precipitated in the interior of the housing as a result of leakage caused by damage or aging processes in the fuel cells or the line system, which can lead to erosion on the fuel cells and/or on inlet and outlet lines. Furthermore, the water condensation, and water which results from it and is present in the housing interior, may also affect the conductivity of the housing internal atmosphere and the insulation effect, therefore adversely affecting the safety of the fuel cell or fuel cell arrangement, with regard to the requirements to be complied with, for example short-circuit resistance, gas tightness and/or water tightness.

German patent document DE 100 31 238 B4 discloses a fuel cell system which has a purging medium line which passes through all the ventilated component housings, with a hydrogen sensor for monitoring the hydrogen concentration being arranged at the output of the last ventilated component housing. When a predetermined limit concentration is exceeded, a warning signal is triggered, or the fuel cell system is shut down.

One object of the present invention is therefore to provide an improved fuel cell system and a better method for operation of such a system, in which the fuel cell system can be operated safely when flammable gas mixtures are formed in the area surrounding the housing.

This and other objects and advantages are achieved by the method according to the invention for operation of a fuel cell arrangement having a plurality of fuel cells which are combined to form a stack and have a common cathode input and cathode output, as well as a common anode input and anode output, and having first components which supply the fuel cells with reactants and second components which process the reaction products of the fuel cells, from all of the housings in whose interior exhaust air containing hydrogen can form. A portion of the respective exhaust air is supplied directly to a combined exhaust air line in which the hydrogen content of the combined exhaust air is determined. The hydrogen which may be contained in the exhaust air may be detected and monitored continuously in a simple manner and largely in real time, by means of a single hydrogen sensor, by causing all or a portion of the exhaust air from all the individual housings to be carried away directly into the combined exhaust air line. This considerably reduces the number of safety-relevant measurement, control and/or regulation devices, by monitoring the hydrogen concentration only in the combined exhaust air line, into which the exhaust air is passed directly, with all the components containing hydrogen.

Such a reduction in the monitoring of safety-critical variables to a single variable—the hydrogen content in the combined exhaust air line—increases the availability of the fuel cell arrangement. Furthermore, the fuel cell arrangement can be shut down automatically without any flammable exhaust gas mixtures being released into the environment. Furthermore, in order to ensure electrical safety, electrical variables, such as the current and/or insulation resistance of the fuel cell arrangement, can be recorded and monitored and can be used as a controlled variable.

In order to maintain a non-critical hydrogen content in the combined exhaust air line, the hydrogen content is monitored, and if a predeterminable limit value is exceeded, the fuel cell arrangement is preferably shut down, and/or an audible and/or visual warning signal is emitted. A high level of operational safety for the fuel cell arrangement is provided by means of such an automatic shut-down process (also referred to as emergency shut down) for the fuel cell arrangement when critical values occur for the hydrogen content in the combined exhaust air line. In this case, automatic shut down is achieved without any flammable gas mixtures being released into the environment.

The respective housing is preferably vented or purged. For this purpose, environmental air and/or an oxidant which is carried in a cathode circuit are/is supplied as supply air to the relevant housing.

With regard to the apparatus for operation of a fuel cell arrangement, one exhaust air line for carrying away exhaust air containing hydrogen originates from each of those housings which have one or more components and in which exhaust gas containing hydrogen can be produced; and the exhaust air line opens directly into a combined exhaust air line, in which a hydrogen sensor is arranged.

In order to monitor the hydrogen content in the combined exhaust air line, the hydrogen sensor is connected to a control device. In this case, the control device monitors the hydrogen content, recorded by the hydrogen sensor, in the exhaust air for exceeding a predeterminable limit value, and produces a switch-off signal as a control signal in order to switch off the fuel cell arrangement when the predetermined limit value is exceeded. If, in contrast, the limit value for the hydrogen content is undershot, then the control device produces a suitable signal S2, in response to which it is possible to switch on the fuel cell arrangement. The control device then allows a user or operator to switch on the fuel cell arrangement, although automatic switching on is not intended, for safety reasons.

Other objects, advantages and novel features of the present invention will become apparent from the following detailed description of the invention when considered in conjunction with the accompanying drawings.

### BRIEF DESCRIPTION OF THE DRAWINGS

The single FIGURE shows a fuel cell arrangement having a plurality of components and at least one housing, which surrounds one or more components and is ventilated.

### DETAILED DESCRIPTION OF THE DRAWINGS

As shown in the FIGURE, a fuel cell arrangement 1 has a plurality of interconnected fuel cells which are arranged one above the other to form a stack 2. In this case, as is shown schematically by a block, each fuel cell has a cathode 3 and an anode 4 as an electrode pair, and an electrolyte which is arranged between them, but is not illustrated in any more detail, for example in the form of a polymer electrolyte membrane (PEM for short), which together form a membrane electrode arrangement (or MEA for short).

The cathodes 3 and the anodes 4 of all the fuel cells in the stack 2 are in this case fed via a common cathode input 3.1 and anode input 4.1, respectively, with an oxidant OM and a fuel BS. The reaction products RP which emerge from the fuel cells are carried away via a respectively associated cathode output 3.2 and anode output 4.2.

The fuel BS and the oxidant OM are used as reactants. Gaseous reactants (reaction gases for short) are generally used, for example hydrogen or a gas containing hydrogen (for example reformat gas) as fuel BS and oxygen or a gas containing oxygen (for example air) as the oxidant OM. The expression reactants means all substances which are involved in the electrochemical reaction, including the reaction products RP, such as an air flow with water vapor and condensed water.

In order to supply the fuel cells with the oxidant OM, in particular fresh air or environmental air, a cathode supply line 5 opens into the cathode input 3.1, in which cathode supply line 5 an air filter 6 for cleaning the fresh air and a compressor 7 for compressing the fresh air can be arranged on the flow input side.

The fuel BS is supplied to the respective anode 4 of the fuel cells via a common anode supply line 8. In general, the fuel BS is taken from a reservoir 9. On the anode output side, the reaction product RP that is carried away, and contains hydrogen, is supplied to the anode input 4.1 again via a feedback path 10 and a recirculation pump 11 arranged therein.

Depending on the design of the fuel cell arrangement 1, its components, such as the stack 2 and/or the components which supply the fuel cells, such as the air filter 6, compressor 7, reservoir 9 and/or the components which process the reaction products RP from the fuel cells, such as the recirculation pump 11, are surrounded by separate housings 12.1 to 12.n or by a common housing (not illustrated in any more detail). As a consequence of leakages caused by mechanical loads or aging processes in one of the components, flammable mixtures may be formed by hydrogen or a gas containing hydrogen entering the respective housing interior, and/or water condensation can occur, resulting in the safety requirements no longer being complied with.

In order to monitor the formation of flammable gas mixtures and/or water condensation, exhaust air lines 13.1 to 13.n which originate from the respective housing 12.1 to 12.n are passed directly into a common combined exhaust air line 14. In this case, the exhaust air lines 13.1 to 13.n can open directly, or an outgoing branch line (not illustrated in any more detail) from the exhaust air line 13.1 to 13.n can open directly, into the combined exhaust air line 14.

In order to feed the respective exhaust air AL1 to ALn out of the respective housing 12.1 to 12.n, an air feed device 15, for example a pump, can be arranged in the respective exhaust air line 13.1 to 13.n as illustrated using the example of the exhaust air line 13.2 of the reservoir 9.

With regard to the flow direction after connection of all the exhaust air lines 13.1 to 13.n and branch lines to the combined exhaust air line 14, a sampling device 16 is arranged thereon and is connected to a hydrogen sensor 17. The hydrogen content MW in the combined exhaust air line 14 is recorded and determined by the hydrogen sensor 17.

The hydrogen sensor 16 is also connected to a control device 18 for example, a controller, and in particular a fuel cell controller. The hydrogen content MW recorded by the hydrogen sensor 16 is supplied to the control device 18. The recorded hydrogen content MW in the combined exhaust air line 14 is determined by an algorithm, implemented in the control device 18, for monitoring the hydrogen content MW, and is monitored for a predeterminable limit value being overshot or undershot. If the recorded hydrogen content MW overshoots the predetermined limit value, then the control device 18 produces a control signal S1 to switch off the fuel cell arrangement 1, and/or to provide a visual and/or audible output of a warning signal. If, in contrast, the recorded hydrogen content MW undershoots the predetermined limit value, then the fuel cell arrangement 1 remains in operation, or can be switched on again if it has previously been shut down because of an increased hydrogen content.

Depending on the nature and configuration of the housing 12.1 to 12.n, these housings may be ventilated. For this purpose, as shown using the example of the reservoir 9, an air supply line 19 opens into the relevant housing 12.2. In this case, fresh air FL or environmental air can be supplied directly to the relevant housing 12.2 as supply air ZL. Alternatively, the relevant housing 12.2 can be supplied with oxidant OM as supply air ZL (see the dashed line). For this purpose, an air supply line 20 branches off from the cathode supply line 5. In this case, the air supply line 20 can branch off from the cathode supply line 5 upstream of or downstream from the air filter 6.

Furthermore, a flame trap 21 can be arranged in the combined exhaust air line 14. This makes it possible to prevent any ignition being passed on into one of the components of the fuel cell arrangement 1.

The exhaust air AL1 to ALn from the relevant housing or housings 12.1 to 12.n can also be passed into the cathode supply line 5 in a manner which is not illustrated in any more detail, in order to reduce combustible gas mixtures in the housing or housings 12.1 to 12.n. In the cathode supply line 5 the exhaust air AL1 to ALn is mixed with the oxidant OM and is then supplied to the cathodes 3 where the hydrogen contained in the exhaust air AL1 to ALn is dissipated by catalytic oxidation on the cathodes 3. This reliably avoids the formation of combustible mixtures by releasing exhaust air AL1 to ALn (=fuel gas) containing hydrogen from the respective housing 12.1 to 12.n. Furthermore, possible water condensation in the housing interior as a result of leakage is largely avoided in that the water vapor contained in the exhaust air AL1 to ALn is reliably dissipated by carrying it away and passing it into the cathode 3, where it can be largely completely reduced.

The foregoing disclosure has been set forth merely to illustrate the invention and is not intended to be limiting. Since modifications of the disclosed embodiments incorporating the spirit and substance of the invention may occur to persons skilled in the art, the invention should be construed to include everything within the scope of the appended claims and equivalents thereof.

List of Reference Symbols
1 Fuel cell arrangement
2 Stack
3 Cathode
3.1 Cathode input
3.2 Cathode output
4 Anode
4.1 Anode input
4.2 Anode output
5 Cathode supply line
6 Air filter
7 Compressor
8 Anode supply line
9 Reservoir
10 Feedback
11 Recirculation pump
12.1 to 12.n Housings
13.1 to 13.n Exhaust air line
14 Combined exhaust air line
15 Air feed device
16 Sampling means
17 Hydrogen sensor
18 Control device
19 Air supply line
20 Branch line
21 Flame trap
AL1 to ALn Exhaust air
ALg Combined exhaust air
BS Fuel
OM Oxidant
RP Reaction product
ZL Supply air

1.-11. (canceled)

12. A method for operating a fuel cell system comprising a plurality of fuel cells which are combined to form a stack and have a common cathode input and output, as well as a common anode input and output; first components which supply the fuel cells with reactants; second components which process the reaction products of the fuel cells; and at least one housing; said method comprising:
supplying at least a portion of exhaust air from all of said at least one housing in whose interior exhaust air containing hydrogen can form, directly to a combined exhaust air line; and
determining a hydrogen content of the combined exhaust air in said combined exhaust air line.

13. The method according to claim 12, wherein all of the exhaust air from the at least one housing is supplied completely to the combined exhaust air line.

14. The method according to claim 12, wherein the hydrogen content is monitored to determine whether it exceeds a predeterminable limit value.

15. The method according to claim 14, wherein if the predeterminable limit value is exceeded, the fuel cell system is shut down.

16. The method according to claim 12, wherein at least one of environmental air and an oxidant carried in a cathode circuit is supplied as supply air to the housing.

17. Apparatus for operating a fuel cell system comprising a plurality of fuel cells which are combined to form a stack and have a common cathode input and output, as well as a common anode input and output; said fuel cell system having first components which supply the fuel cells with reactants and second components which process the reaction products of the fuel cells; said apparatus comprising:
a plurality of housings which enclose at least one of the components or fuel cells;
an exhaust air line that originates from each of the housings for carrying away exhaust air containing hydrogen;
wherein one of the exhaust air line and an outgoing branch line from the exhaust air line opens directly into a combined exhaust air line in which a hydrogen sensor is arranged.

18. The apparatus according to claim 17, wherein the hydrogen sensor is connected to a control device.

19. The apparatus according to claim 17 wherein the control device monitors whether the hydrogen content recorded by the hydrogen sensor in the combined exhaust air exceeds a predetermined limit value.

20. The apparatus according to claim 19, wherein the control device produces a switch-off signal to switch off the fuel cell arrangement if the limit value for the hydrogen content is exceeded.

21. The apparatus according to claim 19, wherein the control device allows the fuel cell arrangement to be switched on by a signal if the limit value for the hydrogen content is undershot.

22. The apparatus according to claim 17, wherein at least one flame trap is arranged in the combined exhaust air line.
